(19) United States
(12) Patent Application Publication
(10) Pub. No.: US 2012/0234429 A1
(43) Pub. Date: Sep. 20, 2012

(54) OMNI-DIRECTIONAL DELIVERY TUBE

(76) Inventor: Lung Shin KO, Taichung City (TW)

(21) Appl. No.: 13/095,280

(22) Filed: Apr. 27, 2011

(30) Foreign Application Priority Data
Mar. 15, 2011 (TW) 100204534

(51) Int. Cl. F16L 9/22

(52) U.S. Cl. 138/155

(57) ABSTRACT

An omni-directional delivery tube includes at least two cascade units, each including an enclosure body and a connection axle. The enclosure body of one cascade unit receives and encloses the connection axle of another cascade unit, and the connection axle of the one cascade unit is connected to the enclosure body of an additional cascade unit. Thus, the combination of cascade units in cascade fashion provides a delivery tube of a desired length by connecting a desired number of cascade units. The second cascade unit that is in cascade connection with the first cascade unit provides angular positioning of a full circle of 360 degrees with respect to the first cascade unit for angular adjustment, and an additional, third cascade unit connected in the same cascade fashion provides a second angular adjustment of a full circle of 360 degrees, whereby omni-directional positioning can be realized without any potential dead zone.

### BACKGROUND OF THE INVENTION

1. Field of the Invention

The present invention relates to the field of liquid delivery tube or article support stand, and in particular to an omni-directional delivery tube, which is capable of omni-directional adjustment of angular positioning without being constrained in radius of curvature by comprising a cascaded combination of at least two cascade units to realize any desired angular adjustment.

2. The Related Arts

A liquid delivery tube is widely used in various applications. Taking machining tools as an example, a cutting operation conducted with a machining tool often generates high temperature due to friction of physical engagement between a tool and a work piece incurring in high speed cutting. To reduce the rate of wear and abrasion of the tool and the amount of deformation of the work piece caused by the high temperature, a liquid coolant is ejected onto the tool and the work piece during to the cutting operation to lower the cutting temperature. The delivery and ejection of the liquid coolant is realized through a delivery tube.

With reference to FIG. 1 of the attached drawings, a conventional universal flexible tube is shown. The universal flexible tube is composed of a plurality of spherical joints 1. Each of the spherical joints 1 has a bottom forming a spherical recess 2 to receive and hold therein the next one of the spherical joints 1. However, the maximum angle of bending that each of the spherical joints 1 can achieve is very limited, and this may lead to failure of bending, as indicated by reference A in the drawing, if an extreme angle of bending is desired. Excessive bending may lead to damage of the spherical joint 1, or alternatively, adjustment to a desired angle may fail. In view of this constraint, it is clear that a large number of spherical joints 1 is needed in making an angular adjustment of a given radius R, and it is also a limitation on the minimum value that the radius R may take. This is a severe problem of the conventional delivery tube of this kind.

FIG. 2 of the attached drawings shows a known nozzle for spraying a cutting fluid, which comprises a base 3 and a nozzle 4. The nozzle 4 comprises a spherical joint 5 that is received and positioned in a socket 6 formed in the base 3, whereby the nozzle 4 is allowed to rotate within a range defined by socket 6 to realize angular adjustment to be set in alignment with a friction site between a tool and a work piece. Although the socket 6 has an opening that is set in an inclined manner pointing at a given direction, yet the opening of the socket 6 is of a limited size that set a severe constraint to the angular adjustment that can be realized by the nozzle 4. This is problematic.

### SUMMARY OF THE INVENTION

An objective of the present invention is to provide an omni-directional delivery tube, which comprises at least two cascade units, each of which comprises an enclosure body and a connection axle. The enclosure body of one cascade unit receives and encloses the connection axle of another cascade unit, and the connection axle of the one cascade unit is subsequently connected, in the same way, to the enclosure body of an additional cascade unit. Thus, the combination of cascade units in cascade fashion provides a delivery tube of a desired length. The second cascade unit that is in cascade connection with the first cascade unit provides angular positioning of a full circle of 360 degrees with respect to the first cascade unit for angular adjustment, and an additional, third cascade unit connected in the same cascade fashion provides a second angular adjustment of a full circle of 360 degrees, whereby omni-directional positioning can be realized without any potential dead zone. The enclosure body forms a through bore that can be circular, elliptical, or polygonal in cross-sectional shape for receiving and enclosing the connection axle of the subsequent cascade unit that is of a corresponding cross-sectional shape of circle, ellipse, and polygon. The present invention is applicable to delivery tubes of various fluids.

A secondary objective of the present invention is to provide an omni-directional delivery tube, which comprises a plurality of cascade units, each of which provides an axis about which angular adjustment of a full circle of 360 degrees can be made, whereby angular adjustment made in the previous axis can be made in combination with that of the subsequent axis to provide a desired spatial positioning. Thus, the more the cascade units are used, the more flexible the spatial angular adjustment can be made with substantially no limitation in angle. The number of cascade units can be expanded without limitation. The present invention may be used as an article support stand, which allows of any desired adjustment and variation according to the environmental factors of an article supported thereby.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a conventional universal flexible tube;

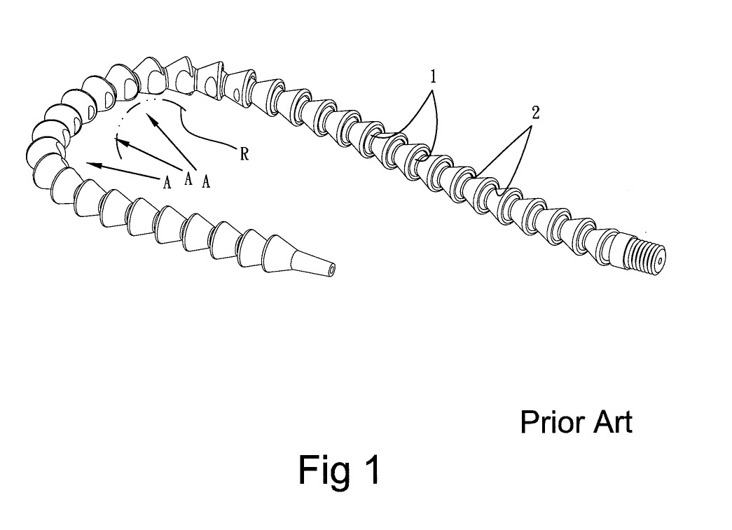

FIG. 2 is a perspective view showing a conventional nozzle for spraying a cutting fluid;

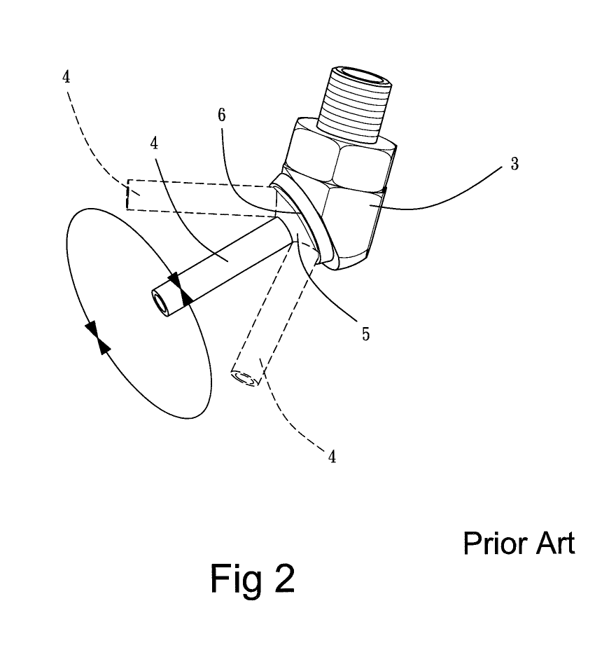

FIG. 3 is a perspective view showing a cascade unit according to the present invention;

FIG. 4 is a cross-sectional view of an omni-directional delivery tube in an assembled form according to an embodiment of the present invention;

FIG. 5 is a cross-sectional view showing an omni-directional delivery tube in an assembled form according to a different embodiment of the present invention;

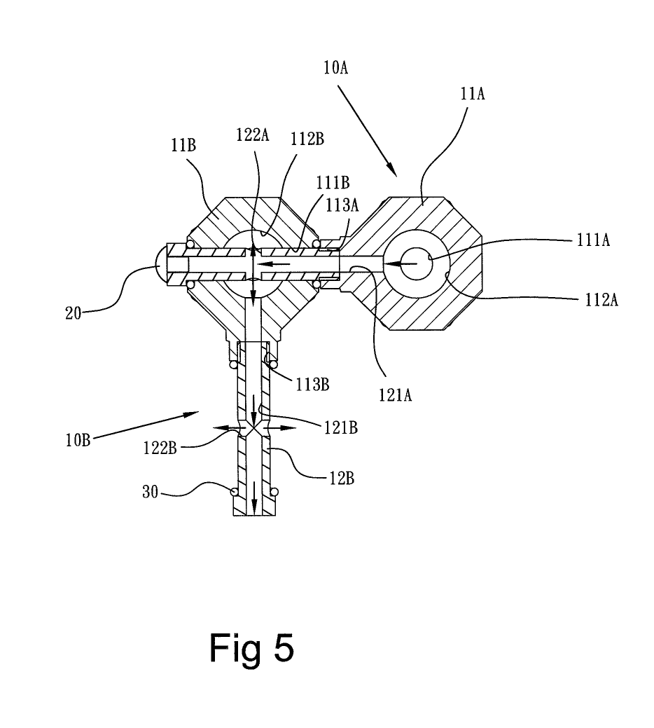

FIG. 6 is a perspective view showing the omni-directional delivery tube in an assembled form according to the present invention;

FIG. 7 is a perspective view illustrating an operation of the omni-directional delivery tube according to the present invention;

FIG. 8 is a perspective view illustrating an operation of the omni-directional delivery tube according to the present invention that is composed of multiple cascade units; and

FIG. 9 is a schematic view illustrating the omni-directional delivery tube according to the present invention serves as a support stand.

### DETAILED DESCRIPTION OF THE PREFERRED EMBODIMENTS

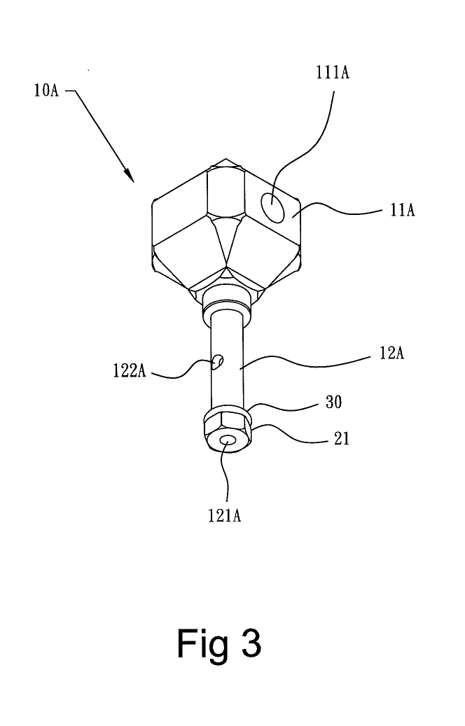

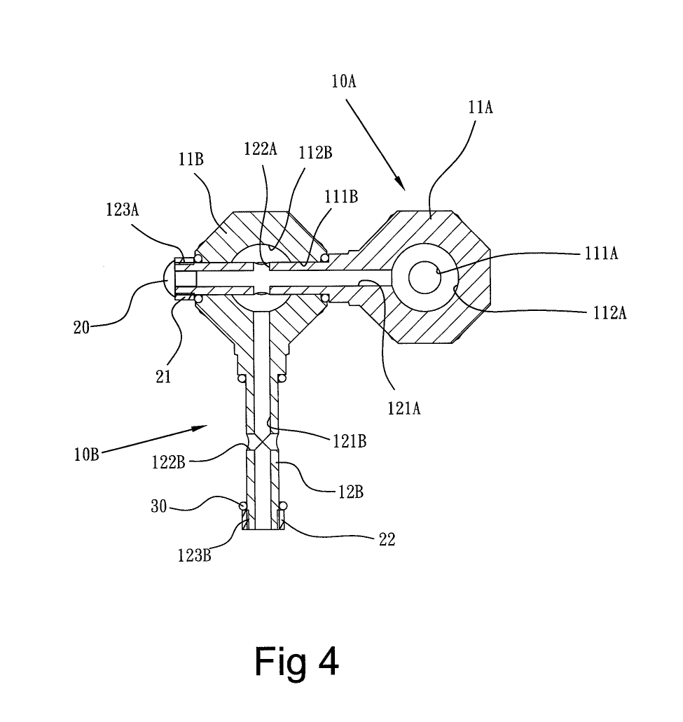

With reference to the drawings and in particular to FIGS. 3 and 4, which are respectively a perspective view of a cascade unit according to an embodiment of the present invention and a cross-sectional view of an omni-directional delivery tube in an assembled form according to the present invention, the omni-directional delivery tube according to the present invention comprises at least two cascade units 10A, 10B. Each cascade unit 10A, 10B comprises an enclosure body 11A, 11B and a connection axle 12A, 12B extending from the enclosure body 11A, 11B. To simplify the following description, the two cascade units 10A, 10B will be respectively referred to as the first cascade unit (or the antecedent cascade unit) 10A and the second cascade unit (or the subsequent cascade unit) 10B. It is also noted that additional cascade units, which may be referred as the third cascade unit and so on, can be included in the omni-directional delivery tube according to the present invention, as well be apparent from the following description.

The enclosure body 11B of the second the cascade units 10B forms a through bore 111B that receives therethrough and thus encloses the connection axle 12A of the first the cascade units 10A, while the connection axle 12B of the second the cascade units 10B can be received through and enclosed by the through bore of an additional cascade unit for expanded cascade connection of the cascade units to provide a omni-directional delivery tube that is of a desired length. The multiple cascade units 10A, 10B so connected in a cascade form allows of angular adjustment in an easy way without any dead zone of adjustment. The connection axle 12A, 12B of each cascade unit 10A, 10B forms a delivery channel 121A, 121B that extends axially along the connection axle and in fluid communication with the through bore 111A, 111B of the enclosure body 11A, 11B. The connection axle 12A, 12B has a circumferential surface that forms, approximately at a central section thereof in the axial direction, a plurality of holes 122A, 122B that extends through a side wall of the connection axle to reach and thus form fluid communication with the delivery channel 121A, 121B. The enclosure body 11A, 11B forms therein an expanded cavity 112A, 112B substantially at a central section of and in fluid communication with the through bore 111A, 111B, whereby a fluid may flow through the through bore 111A, 111B, the expanded cavity 112A, 112B, and the axially-extending delivery channel 121A, 121B to be discharged through the holes 122A, 122B into the subsequent cascade unit 10A, 10B.

The connection axle 12A, 12B can be of a cross-sectional shape of circle, ellipse, or polygon, and corresponding to the cross-sectional shape of the connection axle 12A, 12B, the through bore 111A, 111B of the enclosure body 11A, 11B is shaped as a circular hole, an elliptic hole, or a polygonal hole.

A sealing cap 20 is further provided for closing and sealing any one of the through bore 111A, 111B, the delivery channel 121A, 121B, and the hole 122A, 122B, when they are not in use.

The connection axle 12A, 12B has a free end, which is opposite to the enclosure body 11A, 11B, and the free end forms an external thread 123A, 123B, which is engageable with a nut 21, 22.

The through bore 111A, 111B forms opposite open ends in the enclosure body 11A, 12A and receives a seal ring 30 in each of the open ends.

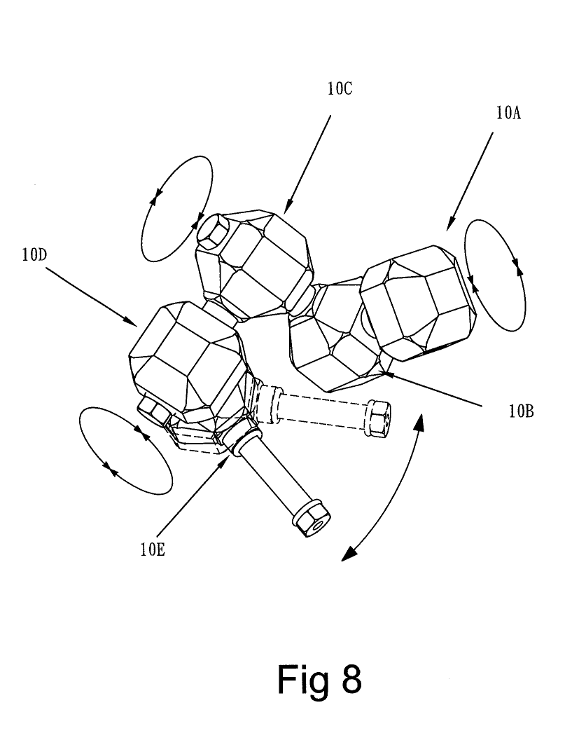

It is noted from the above description that the present invention provides an omni-directional delivery tube, which comprises at least two cascade units 10A, 10B, each of which comprises an enclosure body 11A, 11B and a connection axle 12A, 12B extending from the enclosure body 11A, 11B. The enclosure body 11B of the second one 10B of the cascade units 10B receives and encloses the connection axle 12A of the first one 10A of the cascade units, while the connection axle 12B of the second the cascade units 10B can be coupled to a further subsequent cascade unit so as to provide a omni-directional delivery tube having a desired length. On the other hand, the second cascade unit 10B that is in cascade connection with the first cascade unit provides angular positioning of a full circle of 360 degrees with respect to the first cascade unit 10A for angular adjustment. Each additional subsequent cascade unit 10C (see FIG. 8) that is subsequent to the current combination of cascade units that constitutes the omni-directional delivery tube provides an additional axis for 360-degree angular adjustment in an additional direction. Such an expandable combination of multiple cascade units allows the last one of the cascade units to be set at any desired angular position, through angular adjustment thereof in combination with that of each of the previous units. In this way, a simple conclusion can be made that only three such cascade units provide angular adjustment in three different directions and such angular adjustment can be done with absolutely no dead zone for the adjustment in each of the three directions. Any desired angular position can be obtained within a minimum adjustment range in each of the direction.

Further, the omni-directional delivery tube of the present invention provides an enclosure body 11A, 11B that forms therein a through bore 111A, 111B in a direction substantially perpendicular to a connection axle 12A, 12B extending from the enclosure body 11A, 11B and the connection axle 12A, 12B forms therein an axially-extending delivery channel 121A, 121B, which is in fluid communication with the through bore 111A, 111B. The delivery channel 121A, 121B forms, in a central section of the connection axle 12A, 12B, holes 122A, 122B extending, preferably in a radial direction, through a wall of the delivery channel 121A, 121B. The enclosure body 11A, 11B forms therein an expanded cavity 112A, 112B along the through bore 111A, 111B thereof at a location corresponding to the holes 122A, 122B. The delivery channel 121A, 121B forms an open end in the free end of the connection axle 12A, 12B. A sealing cap 20 is provided to close and seal the through bore 111A, 111B, or the hole 122A, 122B, or the open end of the delivery channel 121A, 121B that is not of instant use for the cascade unit 10A, 10B. As such, a liquid or fluid is allowed to flow through the through bore 111A, 111B of the enclosure body 11A, 11B, the delivery channel 121A, 121B, and the holes 122A, 122B to be discharged through the expanded cavity 112A, 112B into the subsequent enclosure body 11A, 11B to further flow through the delivery channel 121A, 121B of the subsequent unit for further conveyance to a desired site.

Referring to Figure, another embodiment is provided according to the present invention, wherein the connection axle 12A, 12B is made in the form of a threaded axle having an externally-threaded section, and the enclosure body 11A, 11B forms an inner-threaded hole 113A, 113B, whereby the inner-threaded hole 113A, 113B may be set in threading engagement with the threaded axle to secure them together.

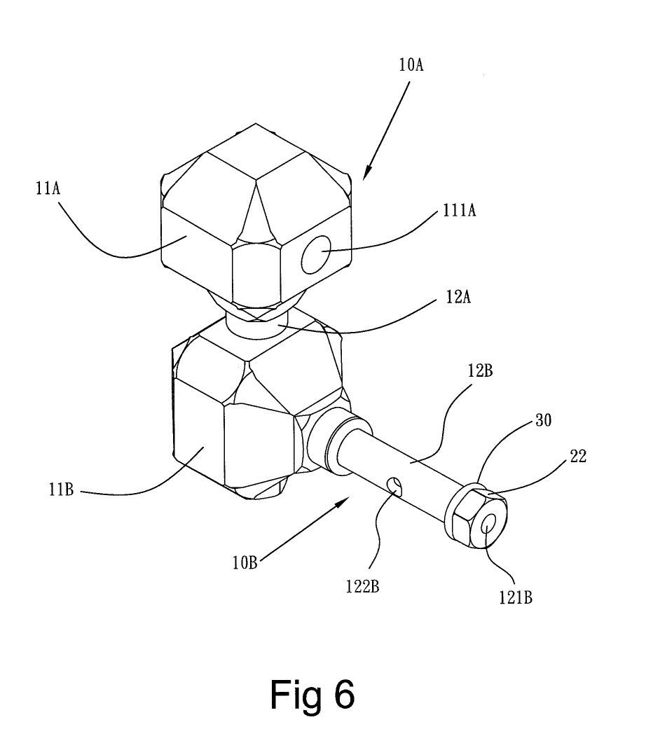

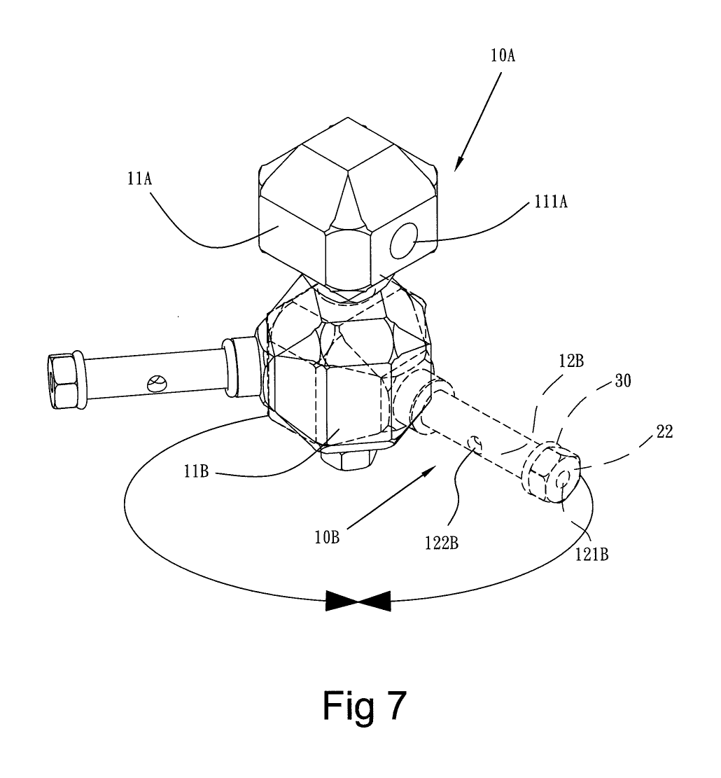

Referring to FIGS. 6 and 7, the present invention provides an omni-directional delivery tube, which comprises at least two cascade units 10A, 10B. Each of the cascade units 10A, 10B comprises an enclosure body 11A, 11B and a connection axle 12A, 12B extending from the enclosure body. The enclosure body 11B of the second cascade unit 10B receives and encloses the connection axle 12A of the first cascade unit 10A, whereby the second cascade unit 10B allows of a full turn of 360-degree angular adjustment or positioning with respect to the first cascade unit 10A.

Referring to FIG. 8, the number of the cascade units 10A-10E can be expanded as desired in a substantially unlimited manner. In the example shown in the drawing, five cascade units 10A-10E are jointed together in a cascade fashion to provide angular adjustment of 360 degrees about four directions. The angular adjustment made in each of the four axes can be selected in combination with those of the other axes so as to achieve, in a very flexible way, any desired adjustment of angular position in a space. This provides excellent applications in various environments.

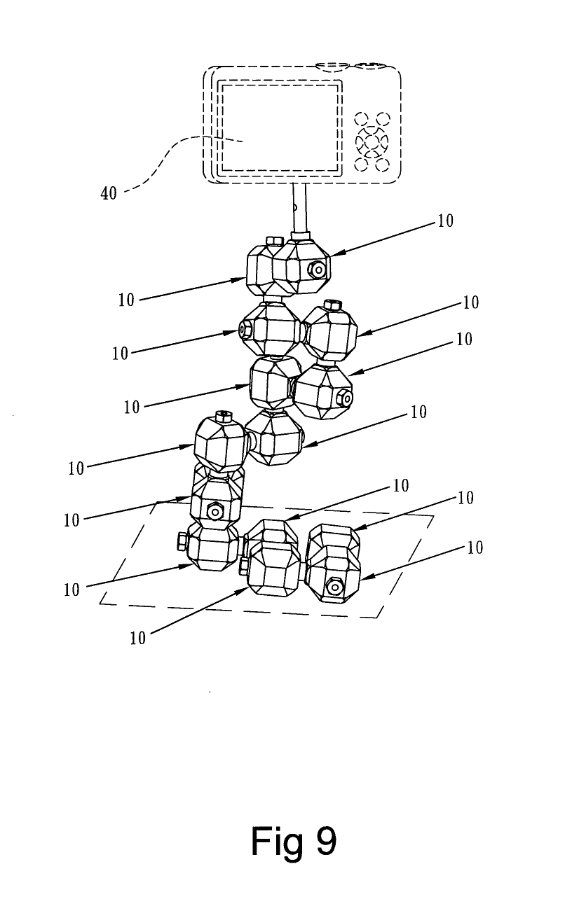

Referring to FIG. 9, the omni-directional delivery tube according to the present invention can be used as an article support stand, wherein a number of cascade units 10 according to the present invention are jointed, in a cascade fashion, to each other to provide a stand that allows of any desired angular positioning through rotation. In the example illustrated in the drawing, a number of cascade units 10 are jointed together to form a stand that is positioned on the ground to support a camera 40, whereby the camera 40 is supported in a firm and stable fashion for taking photos. The cascade units 10 are collapsible after use so as to reduce the collapsed size thereof for easy carrying.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An omni-directional delivery tube, comprising:
at least two cascade units, each of which comprises an enclosure body that defines a bore and a connection axle extending from the enclosure body and forming an axially extending delivery channel in fluid communication with the bore, the connection axle of a first one of the cascade units being received through and enclosed by the bore of a second one of the cascade units to thereby form a combination of cascade units that are jointed to each other in a cascade form and thus provide a delivery tube having a desired length by jointing a desired number of cascade unit, the cascade connection of the cascade units allowing of adjustment of angular position in a full turn of 360 degrees without any dead zone, the connection axle having an outer surface forming a plurality of holes that is in fluid communication with the delivery channel, the enclosure body of each of the cascade units forming therein an expanded cavity in portion of the bore, whereby a fluid is allowed to flow through the bore, the expanded cavity, and the delivery channel of the first cascade unit to be discharged through the holes of the connection axle of the first cascade unit into the second cascade unit.

2. The omni-directional delivery tube as claimed in Clam 1, wherein the connection axle has a cross-sectional shape of one of circle, ellipse, and polygon and the bore of the enclosure body has a circular, elliptical or polygonal cross-sectional shape corresponding to the connection axle.

3. The omni-directional delivery tube as claimed in claim 2, wherein the bore, the hole of the connection axle, the delivery channel of each of the cascade units is selectively closable and thus sealed by a sealing cap.

4. The omni-directional delivery tube as claimed in claim 1, wherein the connection axle of each of the cascade units has a free end forming an external thread engageable with a nut.

5. The omni-directional delivery tube as claimed in claim 1, wherein the enclosure body of each of the cascade units forms an inner-threaded hole and wherein the connection axle forms an externally-threaded section that engages the inner-threaded hole to mount the connection axle to the enclosure body.

6. The omni-directional delivery tube as claimed in claim 1, wherein the bore of each of the cascade units forms two open ends in the enclosure body, a seal ring being received in each of the open ends.

7. The omni-directional delivery tube as claimed in claim 1, which serves an article support stand, wherein the cascade units that are jointed in cascade fashion is rotatable for angular positioning.
